(19) United States
(12) Patent Application Publication
(10) Pub. No.: US 2018/0068268 A1
(43) Pub. Date: Mar. 8, 2018

(54) Shelf Tag Apparatus, Systems, and Methods for Inventory Picking and Tracking

(71) Applicant: Trevor I. Blumenau, Plano, TX (US)

(72) Inventor: Trevor I. Blumenau, Plano, TX (US)

(21) Appl. No.: 15/257,964

(22) Filed: Sep. 7, 2016

(51) Int. Cl. G06Q 10/08; G06F 17/30

(52) U.S. Cl. CPC G06Q 10/0875; G06F 17/30312

(57) ABSTRACT

The present invention is directed to systems and methods of shelf tag apparatus, systems, and processes facilitating inventory picking and inventory tracking. An exemplary system comprises a server module and a shelf tag. The server module has an inventory database, the inventory database configured to store position information of defined regions of shelving, shelf tag to defined region pairing information, and inventory identifier to defined region pairing information, and portable computer to inventory identifier pairing information.

The shelf tag comprises a processor, memory, a wireless network adapter, and a pick indicator. The server module provides an interface to receive and store defined region to shelf tag pairing information in the inventory database. The server module provides an interface to receive and store portable computer to order pairing information in the inventory database. The server module is configured to receive an order, retrieve an inventory identifier for an entry in the order, and retrieve the defined region corresponding to the inventory identifier. The server module is configured to send a control signal to the shelf tag corresponding to the defined region, the pick indicator activating a pick indicator message in response to said control signal.

### FIELD OF THE INVENTION

The invention relates generally to order picking and inventory, and more particularly, to apparatus, systems, and methods for a shelf tag for order picking and inventory tracking.

### BACKGROUND

The order picking operation is one of the key steps in the fulfillment process. It consists of taking and collecting inventory of specified quantities to complete a customer's order prior to shipment. In various types of order picking, the order picker(s) move about the warehouse to shelving within the warehouse in order to collect the inventory necessary for one or more orders. There are often errors in order picking and inventory tracking due to the harried activity and difficulty in locating the inventory. Those difficulty and errors, along with other factors, contribute to the time and error rate in order picking. This invention addresses these and other issues.

### SUMMARY

The present invention is directed to systems and methods of shelf tag apparatus, systems, and processes facilitating inventory picking and inventory tracking. An exemplary system comprises a server module and a shelf tag. The server module has an inventory database, the inventory database configured to store position information of defined regions of shelving, shelf tag to defined region pairing information, and inventory identifier to defined region pairing information, and portable computer to inventory identifier pairing information.

The shelf tag comprises a processor, memory, a wireless network adapter, and a pick indicator. The server module provides an interface to receive and store defined region to shelf tag pairing information in the inventory database. The server module provides an interface to receive and store portable computer to order pairing information in the inventory database. The server module is configured to receive an order, retrieve an inventory identifier for an entry in the order, and retrieve the defined region corresponding to the inventory identifier. The server module is configured to send a control signal to the shelf tag corresponding to the defined region, the pick indicator activating a pick indicator message in response to said control signal.

These and other features, aspects, and advantages of the invention will become better understood with reference to the following description, appended claims, and accompanying drawings.

### BRIEF DESCRIPTION OF THE DRAWINGS

FIG. 1 depicts a diagram of an embodiment of a system according to the current invention as it may exist in operation;

FIG. 2 depicts a diagram of an embodiment of a system according to the current invention as it may exist in operation;

FIG. 3 depicts an embodiment of a shelf tag according to the current invention;

FIG. 4A depicts a representative shelf tag deployment within a facility;

FIG. 4B depicts an alternate representative shelf tag deployment within a facility;

FIG. 5 depicts a flowchart of an inbound inventory process according to the current invention;

FIG. 6 depicts a flowchart of an outbound inventory process according to the current invention;

FIGS. 7A and 7B depicts a housing configuration of an embodiment of a system according to the current invention;

FIGS. 7C and 7D depicts the housing configuration of FIGS. 7A and 7B in various states;

FIGS. 8A and 8B depicts an alternate housing configuration of an embodiment of a system according to the current invention; and

FIG. 9 depicts a housing configuration as it may exist in usage.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

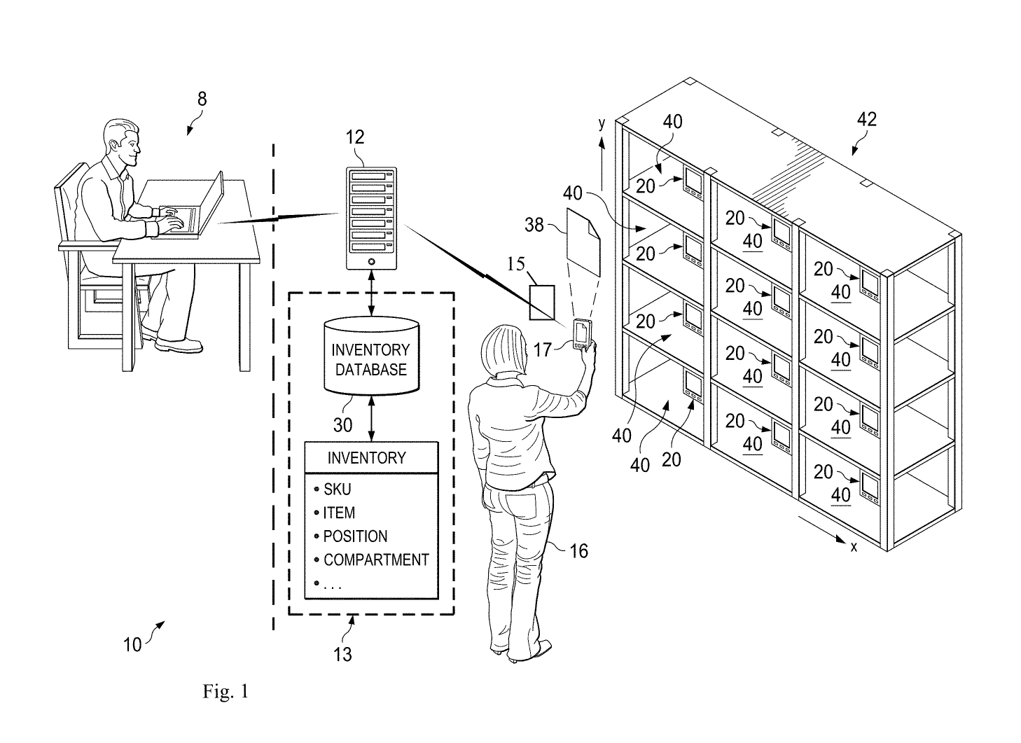

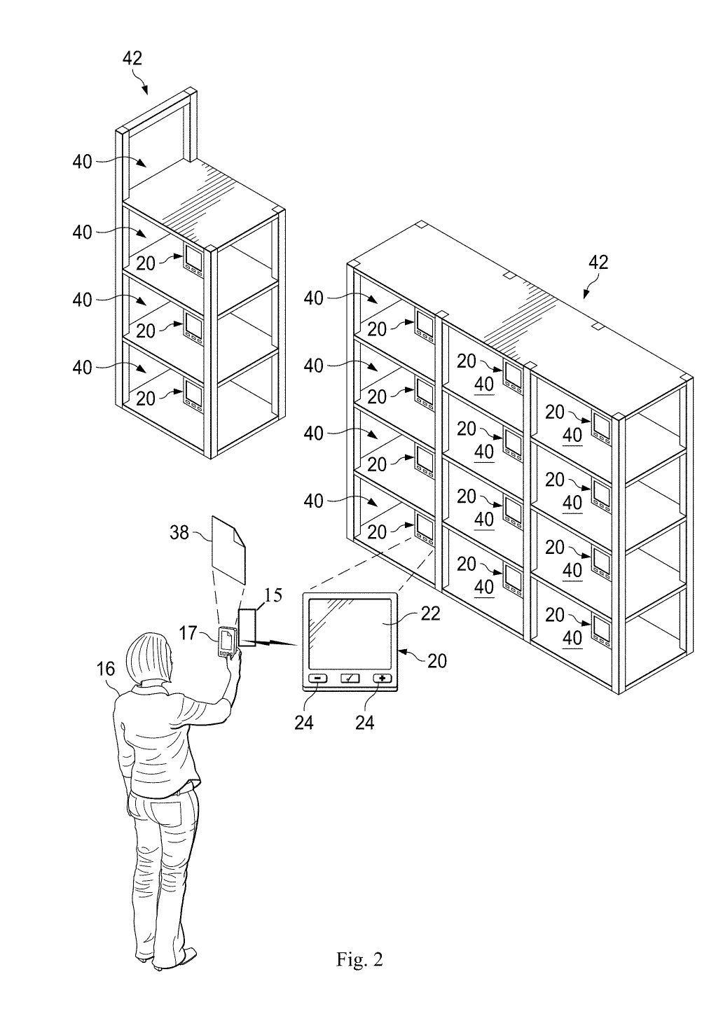

The current invention is directed to apparatus, systems, and methods of a shelf tag for use in inventory picking and inventory tracking. FIGS. 1 and 2 depict a block diagram of embodiments of systems according to the current invention as it may exist in operation, where a customer 08 initiates an order 38 to the system for processing. The depicted system includes a server 12 having a server module 13 which includes an inventory database 30. The inventory is stored on shelving 42 within the facility. Shelf tags 20 are disposed at defined regions 40 within the shelving 42. A worker 16 employs a portable computer 17 having a server module 15 to facilitate picking the inventory.

Shelving 42 is operable to store inventory, such as pallets, carton, boxes, or the like. Common shelving 42 includes multiple parallel vertical levels having a configured height, where inventory may be stored on each vertical level. Each vertical level has a total width x. The shelving 42 is segmented into defined regions 40. As illustrated, each vertical level is further divided horizontally to present a plurality of compartments 40. As used within this specification, each compartment 40 is defined region 40, although virtual or physical segmenting of shelving 42 is within the scope of this invention for a defined region 40. That is to say that the virtual segmenting may or may not coincide with the physical segmenting. Each compartment 40 has a defined width, height, and depth. It should again be noted that FIG. 2 is not to scale and that various shelving 42 can be placed within the facility spaced apart at varying distances causing workers to traverse various walkways 04 to access the necessary compartments 40.

An illustrated embodiment includes a server 12. In exemplary configuration, a server module 13 is disposed on the server 12. The server 12 is a computer operable to carry out the instructions of the server module 13, process orders 38, and other operations. As used in the present disclosure, the term computer is intended to encompass any suitable processing device. For example, although FIG. 1 illustrates a single server 12, the environment may be implemented using one or more servers 12, including a server pool. Indeed, a server and client system may be any computer or processing device such as, for example, a blade server, general-purpose personal computer (PC), Macintosh, workstation, UNIX-based workstation, mobile phone, tablet, or any other suitable device. In other words, the present disclosure contemplates computers other than general purpose computers, as well as computers without conventional operating systems.

The computer includes a processor and memory for storing data and program instructions. Memory may include any memory or database and may take the form of volatile or non-volatile memory including, without limitation, magnetic media, optical media, random access memory (RAM), read-only memory (ROM), removable media, or any other suitable local or remote memory component. Memory may store various objects or data, including source code, object code, classes, applications, databases, repositories storing inventory, shelving, and any other appropriate information including any parameters, variables, algorithms, instructions, rules, constraints, or references thereto associated with the purposes of server 12. Further, a computer may be adapted to execute various operating systems, including Linux, UNIX, Windows, Mac OS, or other suitable operating system.

Server 12 is one that stores one or more applications, where at least a portion of the applications may be hosted applications executed via requests and responses sent to users or clients and communicably coupled to the illustrated environment of FIG. 1. In some instances, the server 12 may comprise a web server or be communicably coupled with a web server accessed and operated over network 18.

The portable computer 17 is a computer, as previously disclosed, with a portable form factor that can be readily moved about a facility, such as a tablet or smartphone. In exemplary configuration, a portable computer module 15 is disposed on a portable computer 17. In exemplary operation, a portable computer module 15 is assigned an identifier and associated with a worker 16.

In exemplary configurations, the system includes specialized storage in the form of an inventory database 30 configured to store inventory and shelving 42 description data. In exemplary configuration, shelving content data, inventory data, user data, are received and stored. One skilled in the art would appreciated that the data may reside in one or more databases, tables, or computers. Representative suitable database systems include MySQL, PostgreSQL, SQLite, Microsoft SQL Server, Oracle, or dBASE. In certain configurations, the inventory database 30 or portions thereof are distributed or synchronized.

In preparation for runtime, the inventory database 30 in memory is initialized and populated. Exemplary databases include a table having rows, “slices,” or other data structures or formats created to store the inventory data. Based on the received shelving configuration, the databases are initialized and pre-populated. General shelving 42 information such as the x axis minimum position, the x axis maximum position, the y axis minimum position, and the y axis maximum position are received and stored. Compartment 40 identifiers are assigned, and the compartment 40 identifier, compartment 40 position, and compartment 40 dimensions, and other information is stored.

Certain embodiments of systems include one or more shelf tags 20 for association with a compartment 40 of the shelving 42. Each shelf tag 20 is secured to a compartment 40 and paired with the compartment 40. An exemplary shelf tag 20 includes a processor, memory, network adapter, a screen 22, and inputs 24, and a fastener 68 enclosed in housing. A suitable network adapter is wired or wireless one, enabling communication with the server 12, a worker's portable computer 17, or other shelf tags 20. The screen 22 is operable to display output from the shelf tag 20. The shelf tag 20 fastener 68 is operable to secure the shelf tag 20 to the associated compartment 40. Suitable fasteners 68 include hook and loop, standoffs, hangers, and the like.

Communication among computers 12 17 and shelf tags 20 is facilitated by a network 18. Network 18 may also include one or more wide area networks (WANs), local area networks (LANs), personal area networks (PANs), mesh networks, all or a portion of the Internet, and/or any other communication system or systems at one or more locations. Network 18 may be all or a portion of an enterprise or secured network, while in another instance at least a portion of the network 18 may represent a connection to the Internet. Further, all or a portion of network 18 may comprise either a wireline or wireless link. In other words, network 18 encompasses any internal or external network, networks, sub-network, or combination thereof operable to facilitate communications between various computing components inside and outside the illustrated environment. The network 18 may communicate by, for example, Bluetooth, Zigbee, WiFi, cellular, Internet Protocol (IP) packets, Frame Relay frames, Asynchronous Transfer Mode cells, voice, video, data, and other suitable information between network addresses.

Certain embodiments implement an improved version of the Bluetooth protocol. Select extracts of the Bluetooth protocol are annexed and incorporated by reference. Bluetooth low energy employs two multiple access schemes: Frequency Division Multiple Access (FDMA) and Time Division Multiple Access (TDMA). Forty physical channels, separated by 2 MHz, are used in the FDMA scheme. Three of these channels are used as advertising channels, and the remaining 37 are used as data channels. The physical channel is sub-divided into time units known as events. Data is transmitted between low energy devices in packets that are positioned in these events. There are two types of events: advertising and connection events. The advertising channel carries the device's discovery and connection establishment information. After a connection is established, a data channel provides link control data and payload for higher level protocols and further action.

In common operation, a shelf tag 20 acts as an advertiser and a server 12, portable computer 17, or another shelf tag 20 act as the receiver. Bluetooth devices use the advertising procedure and scanning procedure to discover nearby devices, to be discovered by devices in a given area, or to form a connection with another Bluetooth device. The discovery procedure and connection procedure are both asymmetrical. A first Bluetooth device needs to listen for devices advertising scannable or connectable advertising events, while another Bluetooth device is actively broadcasting scannable or connectable advertising events over the advertising broadcast physical channel. An advertisement transmission has a minimum transmission time of about 3 milliseconds.

Advertising intervals can be set in a range of 20 milliseconds to 10 seconds. It specifies the interval between consecutive advertising packets. The existing Bluetooth protocol employs a common advertising interval for devices in the same environment, limiting the number of successful connections where there are a high number of advertisers, without resorting to retransmission, which requires additional power or CPU cycles. Certain configurations of the current invention employ a varying advertising interval for the shelf tags 20 in the same environment. More specifically, among a plurality of shelf tags deployed to an environment, a first shelf tag 20 or set of shelf tags 20 are configured with a first configured advertising interval and a second shelf tag 20 or set of shelf tags 20 are configured with a second advertising interval, resulting in effective prioritized connections without additional battery or CPU cycles.

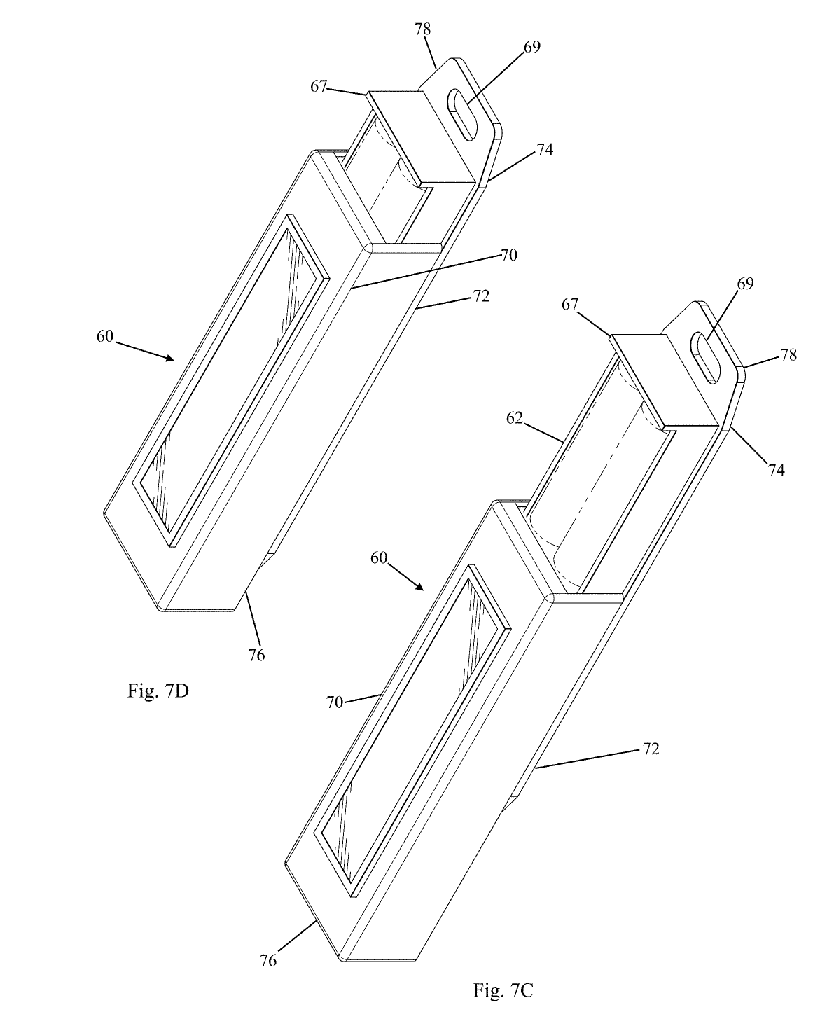

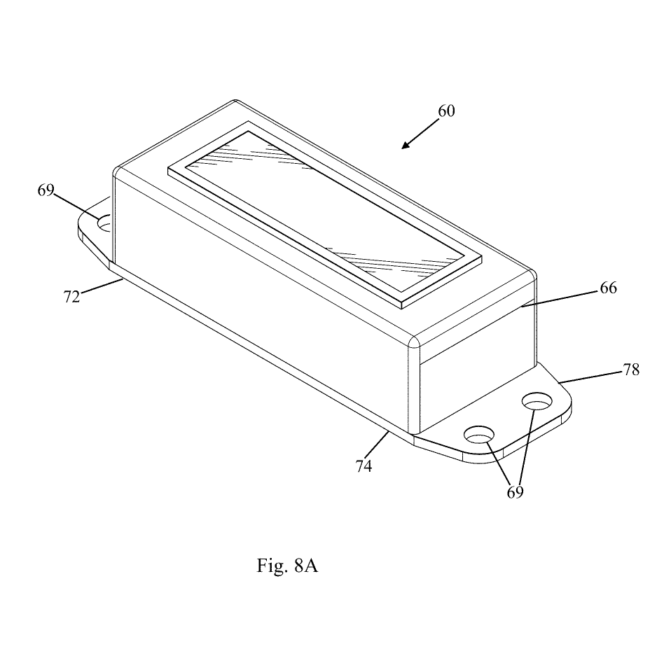

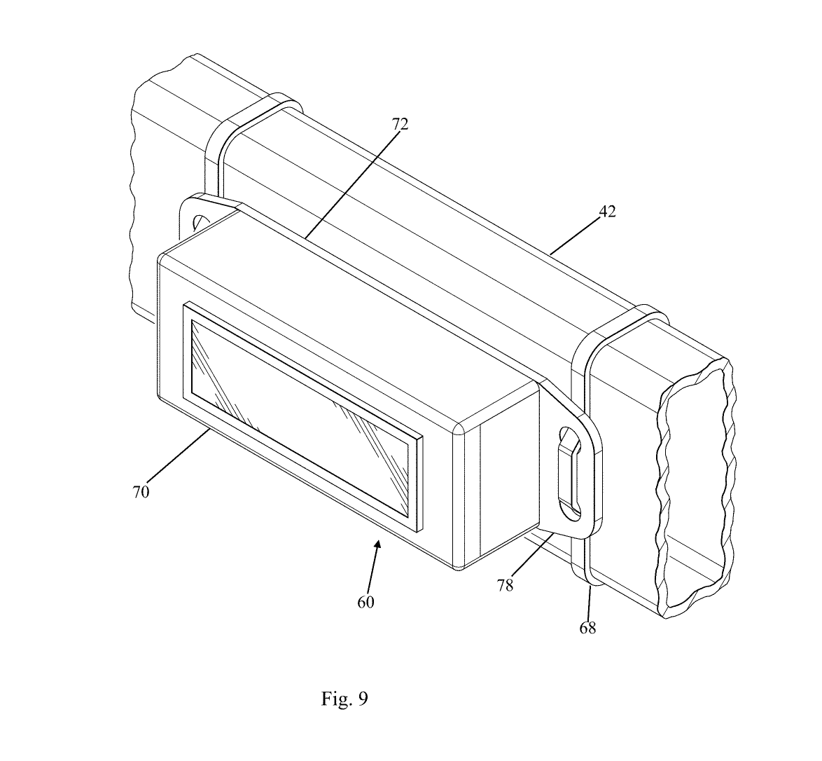

Certain embodiments of the shelf tags 20 are powered by batteries. In certain configurations, the battery level is transmitted by the shelf tag 20 over the network. Certain embodiments of the shelf tag 20 include a housing 60 arrangement for battery access. FIGS. 7A-7D illustrate a first housing 60 configuration. The housing 60 has an upper portion 70, a lower portion 72, a proximal end 74, and a distal end 76. The housing 60 bounds an interior section of the shelf tag 20. The housing 60 further includes a tray 62 dimensioned for slidable travel from the proximal end 74 of the housing 60 to the distal end 76 of the housing 60. The tray 62 includes a recess dimensioned for receipt of one or more batteries 02. The tray 62 optionally further includes an access tab 67 on its proximal end 74. The proximal end 74 of the housing 60 includes a flange 78 on the extending outwardly and from the lower end 72 of the housing 60, whereby the tray 62 may slidably travel past it. The housing 60 includes a mount 69 in the lower section 72 of the housing 60 for receipt of a fastener 68. The illustrated mount 69 is an aperture disposed in the flange 78. In use of this housing 60 configuration, the user inserts batteries 02 in the recess of the tray 62 and pushes the access tab 67 such that the tray 67 slides from the open position of FIG. 7C to the position of FIG. 7D to a completely closed position. FIG. 9 shows the housing 60 mounted to shelving 42 with a fastener 68 applied to the mount 69.

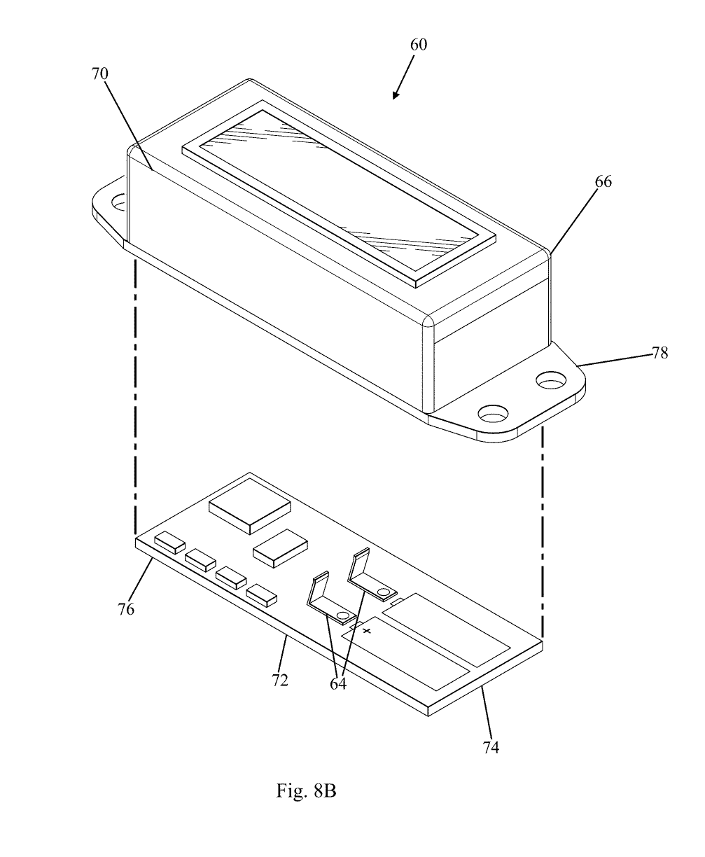

FIGS. 8A and 8B illustrate a second housing 60 configuration. The housing 60 has an upper portion 70, a lower portion 72, a proximal end 74, and a distal end 76. The housing 60 bounds an interior section of the shelf tag 20. The interior section of the housing 60 is dimensioned for receipt of one or more batteries 02. The interior section of the housing 60 further includes one or more secured spring contacts 64. The spring contacts 64 are tension biased, providing an opposing force to a battery 02 in contact with it. The housing 60 further includes a removable access door 66 on its proximal end 74. The proximal end 74 of the housing 60 includes a flange 78 on the extending outwardly and from the lower end 72 of the housing 60, whereby the access door 66 may slidably travel past it. The housing 60 includes a mount 69 in the lower section 72 of the housing 60 for receipt of a fastener 68. The illustrated mount 69 is an aperture disposed in the flange 78. In use of this housing 60 configuration, the user inserts batteries 02 in the interior section of the housing 60, engaging the battery 02 pole against the spring contact 64, loading it, and engages the access door 66 to enclose the battery 02 therein. FIG. 9 shows the housing 60 mounted to shelving 42 with a fastener 68 applied to the mount 69.

In certain embodiments, the processor of the shelf tag 20 is implemented with an instruction set for picking and inventory operations. Representative instructions include, but are not limited to, increment local inventory, decrement local inventory, transmit local inventory count, display local inventory count, and display pick indicator alerts.

The illustrated shelf tag 20 includes a user interface 24 for worker 16 interaction, such as picking and inbound or outbound inventory operations. The user interface comprises may include a plurality of configurable customizable frames or views having interactive fields, pull-down lists, and buttons operated by the user. For example, the user interface may provide interactive elements that allow a user to select from a list of commands, descriptors, or attributes for input into a data field displayed in it. The user interface contemplates any suitable user interface, such as a combination of a text interface, web browser, and command line interface that processes information in the platform and efficiently presents the results to the user visually. An exemplary user interface includes a pick indicator 27. The pick indicator 27 is an element which indicate pick activity to the worker 16 at the compartment 40 with which the shelf tag 40 is associated. Representative suitable pick indicators 27 include a display, light, speaker, or other pick indicators, enabling light signals, text messages, insignia messages, flash sequences, video messages, audio messages, and other pick indicator messages. Representative light messages include turning on or oft different colors, or a flash sequence. Representative text messages include an inventory identifier such as a SKU and quantity. Representative video or insignia messages include a depiction of the inventory. Representative audio messages include an inventory identifier such as a SKU and quantity.

A pick indicator 27 is activated in response to a control signal from the server module 13.

An exemplary user interface 24 includes button inputs 24 which provide confirmation of inbound inventory and outbound inventory. The illustrated input buttons 24 set includes an inventory increment button 24 (shown as “+”), an inventory decrement button 24 (shown as “−”), and a confirm pick button 24 (shown as check mark). Upon worker 16 engagement with the inputs 24, the shelf tag 20 stores the event input. In certain configurations, the local inventory count is incremented or decremented in local memory, such as the local portions of the inventory database 30, or the input is transmitted to the server 12 for inventory updates to the inventory. The local inventory database 30 or portions may be queried via the user interface 24, via remotely over network interface, or synchronized with another inventory database 30.

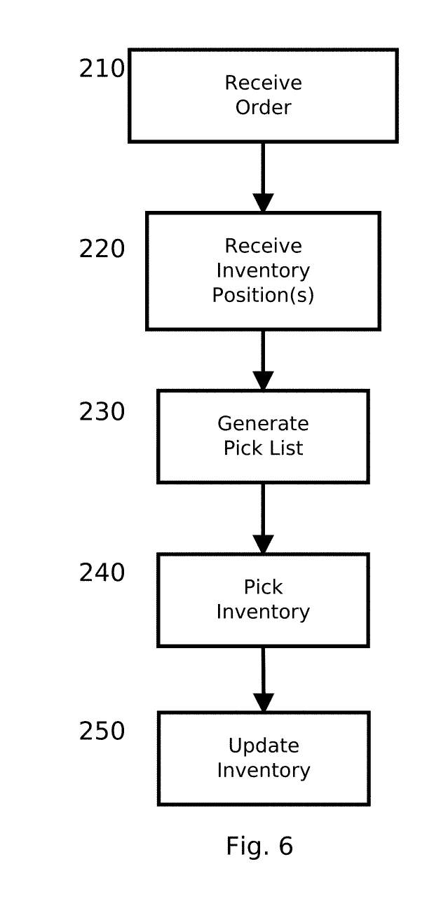

The system is setup for operation. FIG. 5 depicts an exemplary process for inbound inventory processing. At step 110 inventory is received at the facility. At step 120, the inventory type is information received. At step 130, the inventory is placed on the shelving. At step 140, the inventory database is updated. More consideration will be given to each of the steps below.

The shelving 42 is deployed in the facility. A particular facility will have a need for a number of units of storage for a particular location. Accordingly, it will deploy a selected number of shelves 42 having a selected number of vertical levels, a selected number of horizontal columns, and a compartment 40 volume. The system is deployed to the facility. The inventory database 30 is initialized, with the shelving compartment 40 identifier, compartment 40 positions, compartment 40 dimensions, inventory identifiers, and other information being stored. A shelf tag 20 is deployed to each compartment 40. The shelf tag 20 to compartment 40 association is stored in the inventory database 30.

At step 110 inventory is received at the facility. The inventory is segregated by type. At step 120, the inventory identifiers are type(s) retrieved for each type of inventory. The designated compartment 40 for the inventory identifiers is retrieved. At step 130, the inventory is placed in the shelving 42 in the compartments 40 designated for the corresponding inventory identifier. At step 140, the local inventory count is updated.

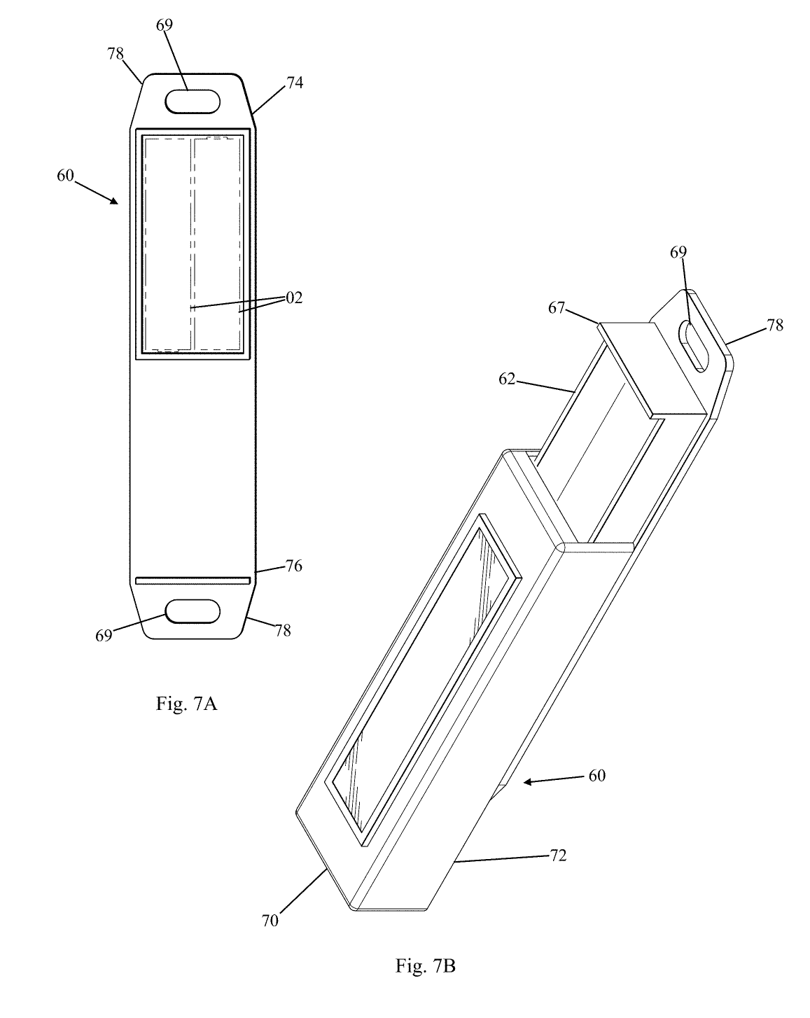

FIG. 6 depicts an exemplary process for outbound inventory processing. At step 210, an order is received. At step 220, the inventory positions for the order are received. At step 230, the pick list is generated. At step 240, the inventory is picked. At step 250, the inventory database is updated. More consideration will be given to each of the steps below.

At step 210, an order requesting merchandise is received. A customer 08 places an order over the network 18. The order 38 includes a list of items requested from inventory. At step 230, the pick list 38 is generated. As illustrated, the pick list is the same as the order 38. The order 38 contains the quantity and item type of inventory to be retrieved.

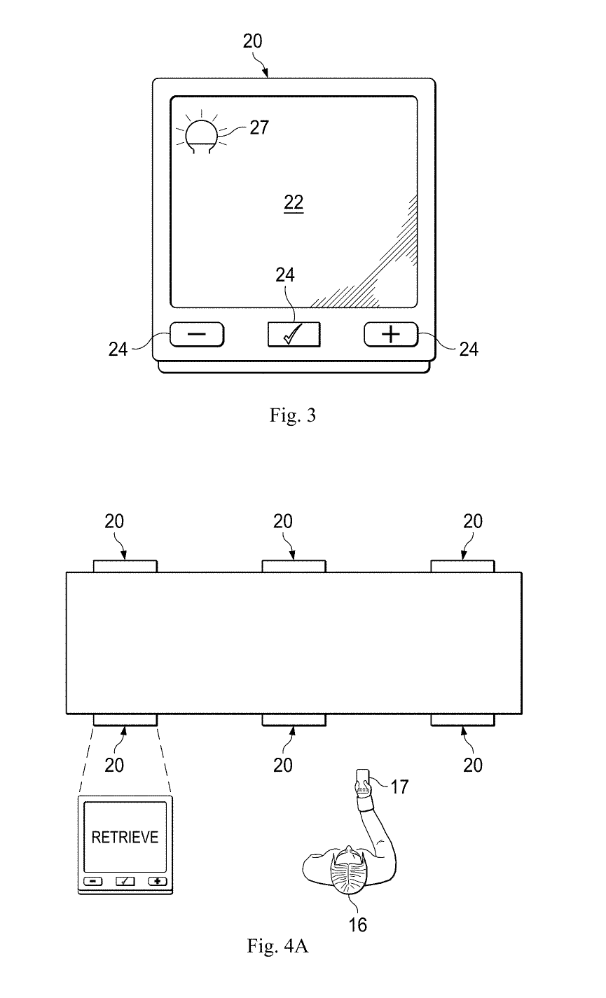

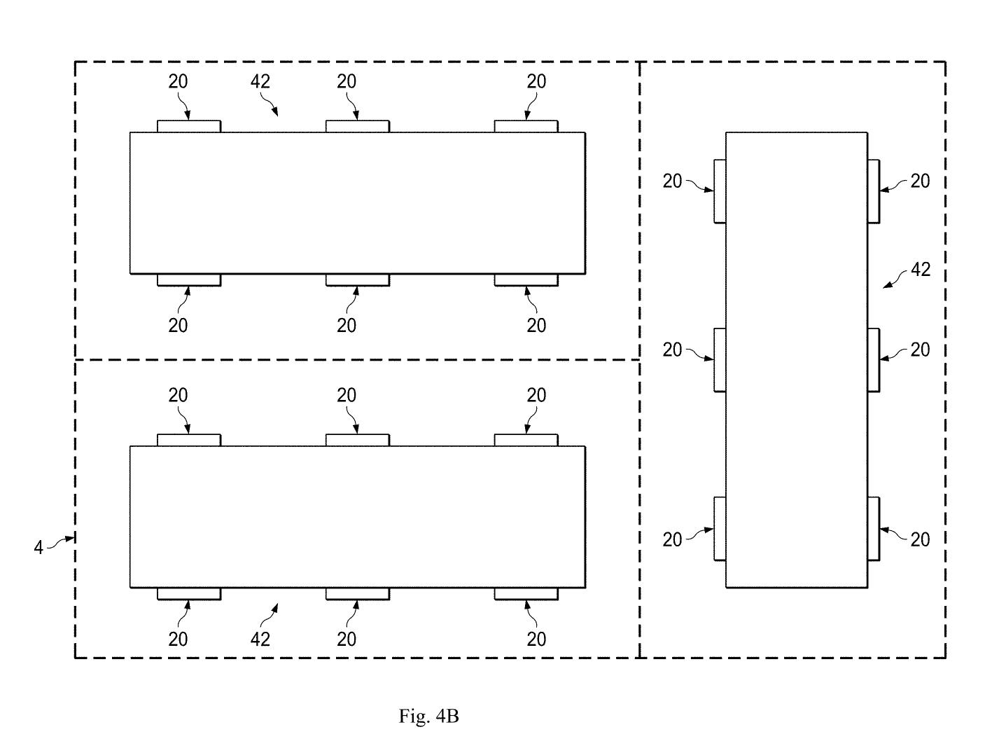

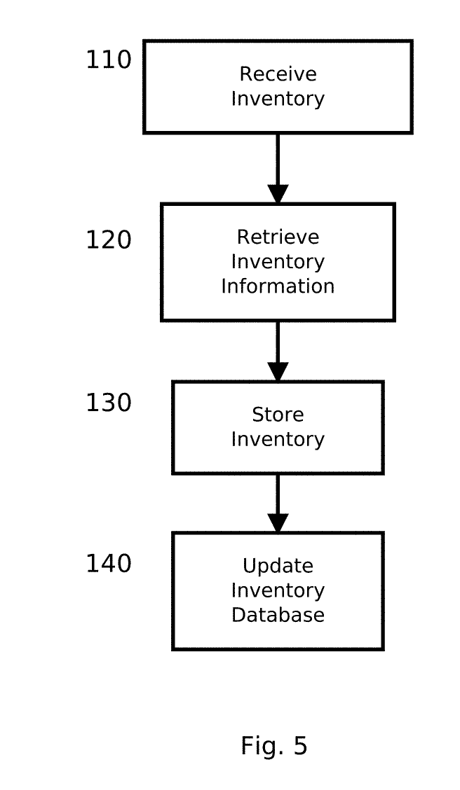

At step 220, the positions for the items in the order 38 are received. The server module 13 retrieves the order 38 and parses the items and retrieves the associated item identifiers from the inventory database 30. The server module 13 further retrieves the compartment 40 information for the associated item identifiers, including the compartment 40 position. The server module 13 transmits the compartment 40 position to the portable computer module 15 receiving the order 38 and transmits control signals to the shelf tags 20 corresponding to the compartment 40 having the associated item identifiers for the order 38. In response, the shelf tag 20 activates the pick indicator 27, as illustrated in FIGS. 3 and 4b. Exemplary pick indicators 27 alerts are customized according to the identifier of the portable computer module 15. For example, where the pick indicator 27 is a light, the pick indicator 27 message's color or flash sequence may be unique to the portable computer module 15 associated with the order 38. For example, where the pick indicator 27 message is a text message, the pick indicator 27 message's text message may be unique to the portable computer module 15 associated with the order 38. It can include retrieval instructions such as “SKU nnn, retrieve n items.”

At step 240, the inventory is picked. After the worker 16 removes the inventory from the compartment 40, the worker 16 presses the inventory pick confirmation button 24, updating the local inventory count. Periodically, the local inventory count may be compared with the remote inventory count.

While the foregoing detailed description has disclosed several embodiments of the invention, it is to be understood that the above description is illustrative only and not limiting of the disclosed invention. It will be appreciated that the discussed embodiments and other unmentioned embodiments may be within the scope of the invention.

Insofar as the description above and the accompanying drawing disclose any additional subject matter that is not within the scope of the single claim below, the inventions are not dedicated to the public and the right to file one or more applications to claim such additional inventions is reserved.

What is claimed is:

1. A shelf tag system facilitating inventory picking and inventory tracking, said system comprising:
a server module having an inventory database and causing a processor and memory to carry out instructions;
said inventory database configured to store position information of defined regions of shelving, shelf tag to defined region pairing information, and inventory identifier to defined region pairing information, and portable computer module to inventory identifier pairing information;
a shelf tag comprising a processor, memory, a wireless network adapter, and a pick indicator,
said server module providing an interface to receive and store defined region to shelf tag pairing information in said inventory database;
said server module providing an interface to receive and store portable computer module to order pairing information in said inventory database;
said server module configured to receive an order, retrieve an inventory identifier for an entry in said order, and retrieve the defined region corresponding to said inventory identifier,
said server module configured to send a control signal to the shelf tag corresponding to said defined region, said pick indicator activating a pick indicator message in response to said control signal.

2. The system of claim 1, wherein said pick indicator is a text message.

3. The system of claim 2, wherein said text message includes an item identifier and quantity.

4. The system of claim 1, wherein said pick indicator is an audio message.

5. The system of claim 4, wherein said audio message includes an item identifier and quantity.

6. The system of claim 1, wherein said pick indicator is a light.

7. The system of claim 1, wherein said control signal includes an identifier of a portable computer module associated with said order.

8. The system of claim 2, wherein said pick indicator message is customized according to said portable computer module identifier.

9. The system of claim 1, wherein said shelf tags further includes an inventory pick confirmation input.

10. The system of claim 9, wherein server module transmits an inventory decrement upon confirmation worker inventory pick confirmation input.

11. The system of claim 1, wherein said shelf tag includes a detachable mount.

12. The system of claim 11, wherein said shelf tag includes housing for battery access, the housing bounding an interior section of said shelf tag;
said housing further comprising a tray dimensioned for slidable receipt in said interior section;
said tray including a recess dimensioned for receipt of a battery; and
a flange extending outwardly from the lower section of the housing including a mount.

13. The system of claim 11, wherein said shelf tag includes housing for battery access, the housing bounding an interior section of said shelf tag;
said housing further comprising an interior section dimensioned for receipt of a battery;
a battery spring contact secured in said interior section, said battery spring contact mounted with bias towards the exterior of said housing; and
a flange extending outwardly from the lower section of the housing including a mount.

14. A shelf tag system facilitating inventory picking and inventory tracking, said system comprising:
a server module having an inventory database and causing a processor and memory to carry out instructions;
said inventory database configured to store position information of defined regions of shelving, shelf tag to defined region pairing information, and inventory identifier to defined region pairing information, and portable computer module to inventory identifier pairing information;
a shelf tag comprising a processor, memory, a wireless network adapter, and a pick indicator, said pick indicator comprising a display;
said server module providing an interface to receive and store defined region to shelf tag pairing information in said inventory database;
said server module providing an interface to receive and store portable computer module to order pairing information in said inventory database;
said server module configured to receive an order, retrieve an inventory identifier for an entry in said order, and retrieve the defined region corresponding to said inventory identifier;
said server module configured to send a control signal to the shelf tag corresponding to said defined region, said control signal includes an identifier of a portable computer module associated with said order;
said pick indicator activating a pick indicator message in response to said control signal.

15. The system of claim 14, wherein said pick indicator message is customized according to said portable computer module identifier.

16. The system of claim 14, wherein said pick indicator message includes an item identifier and quantity.

17. The system of claim 14, wherein said shelf tag includes housing for battery access, the housing bounding an interior section of said shelf tag;
said housing further comprising a tray dimensioned for slidable receipt in said interior section;
said tray including a recess dimensioned for receipt of a battery; and
a flange extending outwardly from the lower section of the housing including a mount.

18. The system of claim 14, wherein said shelf tag includes housing for battery access, the housing bounding an interior section of said shelf tag;
said housing further comprising an interior section dimensioned for receipt of a battery;
a battery spring contact secured in said interior section, said battery spring contact mounted with bias towards the exterior of said housing; and
a flange extending outwardly from the lower section of the housing including a mount.

19. A method of facilitating inventory picking and inventory tracking, said system comprising:
providing a server module having an inventory database and causing a processor and memory to carry out instructions;
said inventory database configured to store position information of defined regions of shelving, shelf tag to defined region pairing information, and inventory identifier to defined region pairing information, and portable computer module to inventory identifier pairing information;
providing a shelf tag comprising a processor, memory, a wireless network adapter, and a pick indicator, said pick indicator comprising a display;
said server module providing an interface to receive and store defined region to shelf tag pairing information in said inventory database;
said server module providing an interface to receive and store portable computer module to order pairing information in said inventory database;
said server module receiving an order, retrieving an inventory identifier for an entry in said order, and retrieving the defined region corresponding to said inventory identifier;
said server module transmitting a control signal to the shelf tag corresponding to said defined region, said control signal includes an identifier of a portable computer module associated with said order,
said pick indicator activating a pick indicator message in response to said control signal.

20. The method of claim 19, wherein said pick indicator message is customized according to said portable computer module identifier.
